(19) United States
(12) Patent Application Publication
(10) Pub. No.: US 2026/0367007 A1
(43) Pub. Date: Nov. 19, 2026

(54) Device for elemental analysis of a sample to be studied by optical emission spectrometry on laser-produced plasma, comprising a sample holder

(71) Applicant: FARIAUT INSTRUMENTS, ORLEANS (FR)

(72) Inventor: François FARIAUT, Saint Jean de la Ruelle (FR)

(21) Appl. No.: 19/141,101

(22) PCT Filed: Dec. 18, 2023
(86) PCT No.: PCT/EP2023/086495

§ 371 Date: Jun. 19, 2025

(30) Foreign Application Priority Data
Dec. 20, 2022 (FR) FR2213977

(51) Int. Cl. G01N 21/71; G01J 3/443

(52) U.S. Cl. CPC G01N 21/718; G01J 3/443

(57) ABSTRACT

A device for elemental analysis of a sample to be studied. The device includes: a stand having a planar surface to support a sample to be studied; a system for generating a laser beam to impact the sample to be studied according to a direction perpendicular to the planar surface of the stand, to generate a plasma generating an optical emission; an optical collector for collecting the optical emission; and a sample holder to rest on the base.

### CROSS-REFERENCE TO RELATED APPLICATIONS

This Application is a Section 371 National Stage Application of International Application No. PCT/EP2023/086495, filed Dec. 18, 2023, and published as WO 2024/133168 A1 on Jun. 27, 2024, not in English, which claims priority to and the benefit of French Patent Application No. FR2213977, filed Dec. 20, 2022, the contents of which are incorporated herein by reference in their entireties.

### FIELD OF THE DISCLOSURE

The present invention relates to the field of high-resolution mapping and analysis of elements in solids.

More particularly, the invention relates, in particular but not exclusively, to a device for the qualitative and quantitative analysis of the elemental chemical composition of a solid sample.

The invention can in particular apply to the elemental analysis of hydrogen and oxygen by optical emission spectrometry on laser-produced plasma, in the field of the nuclear industry, or in the aviation or space industry.

### BACKGROUND OF THE DISCLOSURE

In applications such as the characterization of devices subjected to radioactive sources, or the characterization of the aging ability of devices used in particularly harsh environments, for example in aircrafts or spacecrafts, elemental analysis of metal samples could prove to be essential.

More specifically, it may prove necessary to be able to map these elements within the analyzed sample. Mapping means an identification of the elements making up the sample analyzed and, optionally, the distribution and the bond between the various elements.

Such an analysis could prove particularly useful in studies of metal embrittlement by hydrogen, or in studies of aging of fuel cladding in the presence of oxygen, or in studies of embrittlement of fuel cladding caused by the formation of hydrides, these promoting the propagation of cracks.

There are various known methods of mapping elements present in samples.

One of these methods is elemental analysis by optical emission spectrometry on laser-produced plasma, a technique practiced in a natural atmosphere, also referred to by the English acronym “LIBS” corresponding to the English expression “laser induced breakdown spectroscopy”.

This method applies in particular to the in situ inspection and characterization of samples of parts to be analyzed.

A method and a device for elemental analysis by optical emission spectrometry on laser-produced plasma in the presence of argon is described by the patent document published under number WO 01/33202.

Such an analysis device comprises:
a stand intended to support a sample to be studied;
a system for generating a laser beam intended to impact the sample to be studied according to a direction perpendicular to the stand, to generate a plasma generating an optical emission;
means for collecting the optical emission.

The laser beam generated by the generating system, after shaping by a shaping module, is applied to a sample to be studied via focusing optical means.

A plasma is then created at the impact of the laser beam on the sample to be studied, the plasma generating an optical emission to be analyzed to map the elements composing the studied sample.

Afterwards, the collection of the optical emission of the plasma is carried out by the collection means.

Moving the sample to be studied relative to the laser beam allows access to the distributions of the concentrations of the constituent elements of the surface of the sample, which allows establishing elemental mappings.

The device described in the aforementioned document comprises means for moving the sample to be analyzed.

More specifically, the sample is arranged on a plate within a micrometer margin. This plate, for example motor-driven, allows performing micro-movements according to two direction axes.

The focus produced by the focusing optical means is a critical parameter. This is because this focus must be maintained throughout the analysis of the surface of the sample to be studied.

In the case where the surface of the sample to be analyzed is sufficiently planar (a surface being considered sufficiently planar if its relief does not have height differences greater than the depth of field of the focusing optical means), and if the perfect perpendicularity of this surface with respect to the laser beam is ensured, then there is no focusing problem.

In the case where the surface of the sample is not planar, and/or this surface is not perfectly perpendicular with respect to the laser beam, then an adjustment of the focus must be carried out as the analysis progresses.

A similar device described in the patent document published under number WO 2016203163 is also known.

The device comprises an autofocus system allowing compensating for such flatness and perpendicularity defects with respect to the laser beam of the surface of the sample to be studied. For this purpose, the device implements a sensor which measures any flatness defects of the sample, as well as a motorization of the sample holder able to orient the sample holder according to the measured flatness defect.

This design solves the problem of the need to focus the laser beam, but inherently leads to a complexification of the device.

### SUMMARY

In particular, an objective of the invention is to overcome this drawback of the prior art.

More specifically, an objective of the invention is to provide a device for elemental analysis of a sample to be studied, of the type described before, which allows addressing the flatness and perpendicularity defects with respect to the laser beam of the surface of the sample to be studied in a less complex manner than that proposed by the prior art.

This objective, as well as others that will appear later on, is achieved thanks to the invention which relates to a device for elemental analysis of a sample to be studied, the device comprising:
a stand having a planar surface and intended to support a sample to be studied;
a system for generating a laser beam intended to impact the sample to be studied according to a direction perpendicular to the planar surface of the stand, to generate a plasma generating an optical emission;
means for collecting the optical emission;
characterized in that it comprises a sample holder comprising:
a planar lower face intended to rest on a planar surface of the stand;
a cavity intended to receive the sample;
at least one shoulder forming a bearing surface directed towards the cavity, the bearing surface being inscribed in a plane parallel to the planar lower face of the sample holder;
elastic return means configured to press the sample against the bearing surface;
a cylindrical block having the cavity and the shoulder(s),
a base having the planar lower face, and means for holding the block on the base, the holding means comprising two jaws for clamping the block each having a clamping surface whose generatrices extend perpendicularly to the planar lower face.

Thanks to the device according to the invention, flatness and perpendicularity defects as described before are addressed, in a manner that is less complex than that proposed by the prior art (autofocus).

This is because the design of the device according to the invention allows guaranteeing that the surface of the sample to be studied extends perpendicularly to the laser beam generated by the generating system of the device.

Thanks to the sample holder, the sample is pressed onto the bearing surface and the surface of the sample then extends in the plane that is parallel to the planar lower face of the sample holder. In this manner, and because the planar lower face of the sample holder rests on the planar surface of the stand, the plane in which the face to be studied of the sample extends parallel to the planar surface of the stand and thus perpendicular to the laser beam which, during operation of the device, extends perpendicular to the planar surface of the stand.

By ensuring that the surface of the sample to be analyzed is pressed against the shoulder, there is no focusing problem when studying the surface of the sample to be studied. The sample holder of the device according to the invention forms a simple mechanical solution, and in particular simpler than that using an autofocus.

For example, the cylindrical block is obtained by precision machining.

This cylindrical block allows presenting faces extending, when the sample holder is integrated into the device, parallel or perpendicular to the planar lower face of the sample holder, and to the planar surface of the stand.

More specifically, the radially outer surface of the block and more specifically the generatrices of this surface then extend perpendicularly to the planar surface of the stand whereas the bases of the cylinder extend parallel to the planar surface of the stand.

Thanks to the two clamping jaws of the block, each of which having a clamping surface whose generatrices extend perpendicularly to the planar lower face, it is ensured that these clamping jaws come into flat contact against the radially outer surface of the block during clamping, thereby ensuring that the clamping does not cause an angular tilting of the central axis of the cylindrical block with respect to the planar surface of the stand.

Conversely, tightening using a screw which would exert a point stress, perpendicular to the central axis of the cylindrical block, on the radially outer surface of the cylindrical block, could lead to such an offset distorting the measurement.

Preferably, the cylindrical block is axisymmetrically cylindrical.

Advantageously, the shoulder has an annular shape.

Such a shoulder allows forming a continuous bearing surface on which the sample can be pressed.

According to an advantageous feature, the sample holder comprises a stop coupled to the block and forming a support for the elastic return means.

Thanks to such a stop distinct from the block, the positioning of the sample in the block, and then of the elastic return means, and finally of the stop are implemented simply, while helping guarantee the proper positioning of the sample with respect to the axis of the laser beam.

Preferably, the elastic return means have at least two upper contact points intended to be in contact with the sample, and at least two lower contact points intended to bear against the stop.

In this manner, it is ensured that the support taken by the elastic return means against the stop and the forces applied by the elastic return means are exerted in an evenly distributed manner to properly press the sample against the bearing surface formed by the shoulder.

According to an advantageous embodiment, the elastic return means is in the form of a wavy spring washer.

Such a wavy spring washer is suitable for achieving the elastic return guaranteeing the proper pressing of the sample against the bearing surface.

Even more preferably, the spring washer has an S-profile according to a side view.

Such a spring washer perfectly ensures that the sample is properly pressed against the bearing surface.

The invention also relates to a method for elemental analysis of a sample to be studied by optical emission spectrometry on laser-produced plasma, comprising a step of preparing a sample and a step of positioning the sample on a stand for analysis thereof,
characterized in that the step of preparing a sample comprises a sub-step of forming by polishing on the sample a planar face to be studied,
and in that the positioning step includes the use of a sample holder comprising:
a planar lower face intended to rest on the planar surface of the stand;
a cavity intended to receive the sample;
at least one shoulder forming a bearing surface directed towards the cavity, the bearing surface being inscribed in a plane parallel to the planar lower face of the sample holder;
elastic return means configured to press the sample against the bearing surface,
a cylindrical block having the cavity and the shoulder(s),
a base having the planar lower face, and means for holding the block on the base, the holding means comprising two jaws for clamping the block each having a clamping surface whose generatrices extend perpendicularly to the planar lower face, and in that the positioning step comprises:
a sub-step of inserting the sample into the sample holder and positioning the planar face to be studied against a bearing surface of the sample holder inscribed in a plane parallel to a planar lower face of the sample holder intended to rest on a planar surface of the stand;
a sub-step of adding elastic return means for pressing the planar face to be studied of the prepared sample against the bearing surface.

The analysis method can be implemented by the device according to the aforementioned invention.

This analysis method guarantees the proper positioning of the sample with respect to the axis of the laser beam.

### BRIEF DESCRIPTION OF THE DRAWINGS

Other features and advantages of the invention will become apparent upon reading the following description of different preferred embodiments of the invention, given as illustrative and non-limiting examples, and from the appended drawings, including:

FIG. 1 is a schematic representation in side view of a device for elemental analysis of a sample to be studied according to the invention, comprising in particular a sample holder resting on a stand;

FIG. 2 is a schematic representation according to a cross-sectional view of the sample holder of a device according to the invention, the sample holder comprising a block receiving the sample, elastic return means and a stop allowing pressing the sample in the block, as well as a base and means for holding the block on the base;

FIG. 3 is a schematic representation in a cross-sectional view of the block receiving the sample and housing within it the elastic return means and the stop;

FIG. 4 is a schematic representation In cross-section of the block alone;

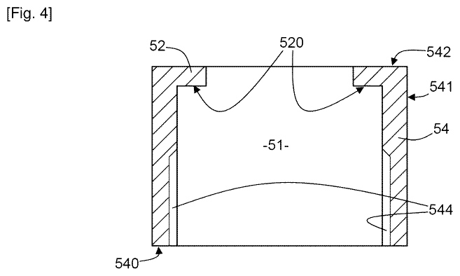

FIG. 5 is a schematic representation in cross-section of the stop;

FIG. 6 is a schematic representation in a profile view of the elastic return means in particular in the form of a wavy washer;

FIG. 7 is a schematic representation in top view of the sample holder illustrating in particular the means for holding the block on the base.

### DETAILED DESCRIPTION

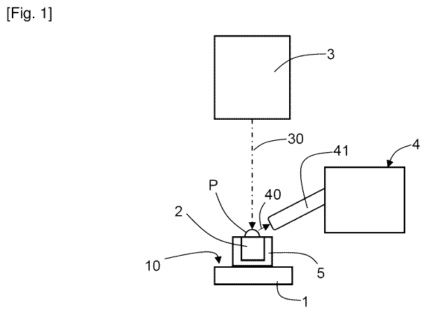

Referring to FIG. 1, a device for elemental analysis of a sample to be studied is shown.

The analysis device is of the type projecting a laser beam 30 onto a sample 2 to be studied to generate a plasma P generating an optical emission 40 intended to be collected and analyzed.

Still with reference to FIG. 1, the device comprises:
a stand 1 intended to support the sample 2 to be studied, the stand 1 having a planar surface 10;
a system 3 for generating a laser beam 30 intended to impact the sample 2 to be studied, to generate a plasma P generating the optical emission 40;
means 4 for collecting the optical emission 40;
a sample holder 5 intended to carry the sample 2 to be studied above the stand 1, the sample holder 5 resting on the stand 1, and more specifically on the planar surface 10 of the stand 1.

The system 3 for generating a laser beam 30 is configured to emit the laser beam 30 according to a direction perpendicular to the planar surface 10 of the stand 1.

The system 3 for generating a laser beam 30 comprises a source for generating a laser beam, means for shaping the laser beam, as well as optical means for focusing the laser beam.

The generating system 3 is configured so that the focus of the laser beam 30 is adapted to the sample 2 to be studied.

This focus is partially defined by a depth-of-field within which the surface of the sample 2 to be studied impacted by the laser beam 30 should be located.

In turn, the means 4 for collecting the optical emission 40 comprise for example an optical fiber 41 directed towards the plasma P, and positioned the closest to the plasma P to collect the optical emission 40.

The sample holder 5 is described in more detail hereinafter.

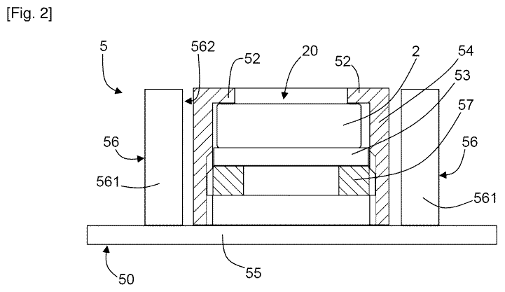

Referring to FIGS. 2, 3 and 7, the sample holder 5 comprises:
a block 54;
a base 55;
means 56 for holding the block 54 on the base 55.

In a simplified design, the sample holder 5 comprises:
a planar lower face 50 intended to rest on the planar surface 10 of the stand 1;
a cavity 51 intended to receive the sample 2;
a bearing surface 520 directed towards the cavity, this bearing surface 520 being inscribed in a plane parallel to the planar lower face 50 of the sample holder 5;
elastic return means 53 configured to press the sample 2 against the bearing surface 520.

According to the present embodiments, the planar lower face 50 is presented by the base 55.

When the sample holder 5 is placed on the stand 1, then the planar lower face 50 of the base 55 is in flat contact with the planar surface 10 of the stand 1.

The cavity 51, intended to receive the sample 2, is presented by the block 54.

The sample holder 5 also comprises at least one shoulder 52 which forms the bearing surface 520.

In this case, the bearing surface 520 is formed by one single shoulder 52.

This shoulder 52 is presented by the block 54, which is intended to receive the sample 2 in its cavity 51.

In this case, the shoulder 52 has an annular shape. Thus, this shoulder 52 corresponds to an inner shoulder of the block 54 which is, according to the present embodiment, cylindrical, and more specifically axisymmetrically cylindrical about a central axis.

Thus, the bearing surface 520 extends from a peripheral wall of the block 54 in the direction of the central axis of the axisymmetrically cylindrical block 54.

The axisymmetrically cylindrical block 54 has:
a radially outer surface 541;
a lower surface 540 inscribed in one of the two bases corresponding to the axisymmetrically cylindrical shape;
an upper surface 542 inscribed in the other one of the two bases of the axisymmetrically cylindrical shape.

The cavity 51 opens onto the lower face 540.

The block 54 has an aperture 543 centered on the upper surface 542, and opening into the cavity 51 to enable the laser beam 30 to impact the sample 2.

Being cylindrical, all of the generatrices of the radially outer surface 541 extend perpendicularly to the lower face 540 and to the upper face 542.

Similarly, these generatrices extend perpendicularly to a plane in which the bearing surface 520 is inscribed.

As functionally detailed hereinafter, the block 54 comprises an internal thread 544.

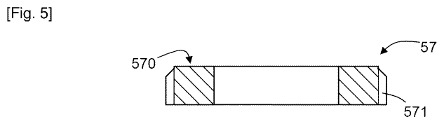

Referring to FIGS. 2, 3 and 5, the sample holder 5 comprises a stop 57.

This stop 57 is coupled to the cylindrical block 54 and forms a support for the elastic return means 53. In particular, this stop 57 has an annular shape.

The stop 57 is coupled to the cylindrical block 54 by being screwed inside the cavity 51.

To this end, the stop 57 has an external thread 571 which can be screwed complementarily with the internal thread 544.

The stop 57 and the block 54 are configured so that a screwing of the stop 57 into the cavity 51 brings an upper surface 570 of the stop 57 into a plane that is parallel to the plane in which the bearing surface 520 is inscribed.

In order for the block 54 and the stop 57 to have strictly geometric shapes, and in particular to have faces and sides inscribed in parallel or perpendicular planes, these two parts are manufactured by high-precision machining, or by 3D printing.

Referring to FIGS. 2, 3 and 6, the elastic return means 53 are in the form of a wavy spring washer.

More specifically, the spring washer has an S-profile according to a side view.

Such a wavy spring washer enables the elastic return means 53 to have at least two upper contact points 531, and in this case three upper contact points 531 intended to be in contact with the sample 2, and at least two lower contact points 532, and in this case three lower contact points 532 intended to bear against the stop 57, and more specifically against the upper surface 570 of the stop 57.

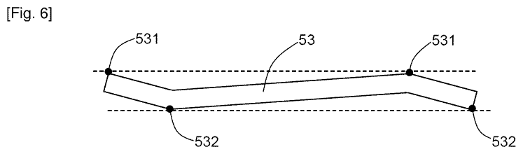

Because of the profile view of FIG. 6, only two upper contact points 531 and two lower contact points 532 are visible, nevertheless, it can easily be understood that the washer has a third upper point 531 behind the upper point 531 located on the right-hand part of the figure, and a third lower contact point 532 behind the lower contact point 532 located on the left-hand part of the figure.

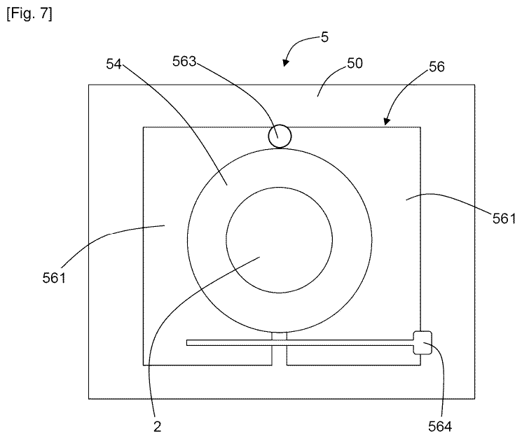

Now, with reference to FIGS. 2 and 7, the holding means 56 are described in more detail hereinafter.

These holding means 56 are fastened on the base 55. The holding means 56 comprise two jaws 561 for clamping the block 54.

Each jaw 561 has a clamping surface 562 whose generatrix or generatrices extend(s) perpendicularly to the planar lower face 50 presented by the base 55.

More specifically, the holding means 56 are configured so that the two clamping jaws 561 could be moved towards each other while preserving the perpendicularity of the generatrices of the clamping surfaces 562 with respect to the planar lower face 50.

To this end, and more specifically with reference to the embodiment of FIG. 7, the holding means 56 comprise a hinge 563 defining a pivot axis of one of the jaws relative to the other one of the jaws 561 extending perpendicularly to the planar lower face 50. This pivot axis extends perpendicularly with respect to the planar lower face 50. According to another preferred embodiment, not shown, the holding means 56 are made of an at least partially elastically deformable material and comprise a thickness reduction at the location of the hinge 563. In this manner, the two jaws can be spaced apart from each other to enable the insertion of the block 54.

In addition, the holding means 56 comprise a bolt 564 coupled to the two clamping jaws 561 to enable the two clamping jaws 561 to be brought closer together.

Such clamping means guarantee that the block 54 is clamped in a position in which the central axis of the block 54 extends perpendicularly to the planar lower face 50.

The invention also comprises a method for elemental analysis of the sample 2 to be studied by optical emission spectrometry on laser-produce plasma.

This method comprises a step of preparing a sample 2, then a step of positioning the sample 2 on the stand 1 for analysis thereof.

In particular, the step of preparing a sample 2 comprises forming the sample 2.

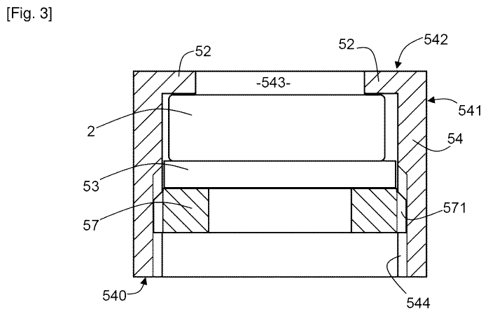

As schematically illustrated by FIGS. 2 and 3, the sample 2 has an essentially axisymmetrically cylindrical shape.

For the purposes of the analysis, the material to be analyzed corresponds, for example, to a metal strip included in a resin block designed so that the strip to be analyzed is flush with one of the bases of the resin block. This block forms sample 2 to be studied.

During the step of preparing the sample 2, it is proceeded with a sub-step of forming a planar face to be studied by polishing on the sample 2.

To this end, the resin block is polished by bringing its base, on which the strip of materials to be analyzed is flush, into contact with an abrasive surface.

Next, the step of positioning the sample 2 on the stand 1 for analysis thereof includes the use of the sample holder 5 described before.

Thus, this positioning step comprises:
a sub-step of inserting the sample 2 into the sample holder 5, and in particular of inserting the sample 2 into the cavity 31 of the block 54, and of positioning the planar face to be studied against the bearing surface 520 of the sample holder 5;
a sub-step of adding the elastic return means 53 for pressing the planar face to be studied of the sample 2 against the bearing surface 520.

Next, of course, the stop 57 is screwed so as to enable the elastic return means to bear against this stop 57 and to exert an elastic return force on the sample 2 to keep it pressed.

Afterwards, the block 54 is positioned on the base 55 and clamped by the holding means 56.

Next, the analysis by optical emission spectrometry on laser-produced plasma can be performed, the sample holder 5 guaranteeing that the surface of the sample 2 to be analyzed is properly positioned perpendicular to the laser beam 30, and polishing guaranteeing that the surface condition of the sample 2 to be analyzed does not have any height differences located outside the depth of the field-of-focus of the generating system 3.

Although the present disclosure has been described with reference to one or more examples, workers skilled in the art will recognize that changes may be made in form and detail without departing from the scope of the disclosure and/or the appended claims.

1. A device for elemental analysis of a sample to be studied, the device comprising:
a stand having a planar surface and configured to support the sample to be studied;
a system arranged to generate a laser beam to impact the sample to be studied according to a direction perpendicular to the planar surface of the stand, to generate a plasma generating an optical emission;
an optical collector positioned to collect the optical emission; and
sample holder comprising:
a planar lower face resting on the planar surface of the stand;
a cavity positioned to receive the sample;
at least one shoulder forming a bearing surface directed towards the cavity, the bearing surface being inscribed in a plane parallel to the planar lower face of the sample holder;
an elastic return configured to press the sample against the bearing surface;
a cylindrical block having the cavity and the at least one shoulder; and
a base having the planar lower face, and a holder for holding the block on the base, the holder comprising first and second jaws for clamping the block each having a clamping surface whose generatrices extend perpendicularly to the planar lower face.

2. The device according to claim 1, wherein the cylindrical block is axisymmetrically cylindrical.

3. The device according to claim 2, wherein the shoulder has an annular shape.

4. The device according to claim 1, wherein the sample holder comprises a stop coupled to the block and forming a support for the elastic return.

5. The device according to claim 1, wherein the elastic return comprises at least two upper contact points positioned to be in contact with the sample, and at least two lower contact points positioned to bear against the stop.

6. The device according to claim 1, wherein the elastic return comprises a wavy spring washer.

7. The device according to claim 6, wherein the spring washer has an S-profile according to a side view.

8. A method for elemental analysis of a sample to be studied by optical emission spectrometry on laser-produced plasma, the method comprising:
preparing the sample; and
positioning the sample on a stand for analysis thereof,
wherein preparing the sample comprises forming a planar face to be studied by polishing on the sample;
wherein the positioning includes using a sample holder comprising:
a planar lower face configured to rest on the planar surface of the stand;
a cavity to receive the sample;
at least one shoulder forming a bearing surface directed towards the cavity, the bearing surface being inscribed in a plane parallel to the planar lower face of the sample holder;
an elastic return configured to press the sample against the bearing surface;
a cylindrical block having the cavity and the at least one shoulder; and
a base having the planar lower face, and a holder for holding the block on the base, the holder comprising first and second jaws for clamping the block each having a clamping surface whose generatrices extend perpendicularly to the planar lower face; and
wherein the positioning comprises:
inserting the sample into the sample holder and positioning the planar face to be studied against the bearing surface of at least one of the at least one shoulder of the sample holder inscribed in the plane parallel to the planar lower face of the sample holder configured to rest on the planar surface of the stand;
adding the elastic return for pressing the planar face to be studied of the sample against the bearing surface.
